(19) United States
(12) Patent Application Publication
(10) Pub. No.: US 2003/0170601 A1
(43) Pub. Date: Sep. 11, 2003

(54) DNA model based on nucleotides

(76) Inventors: Raymond W. Scheetz, Hattiesburg, MS (US); Pete A. Pickett II, Hattiesburg, MS (US)

Correspondence Address: Craig M. Lundell, Howrey Simon Arnold & White, P.O. Box 4433, Houston, TX, 77210, US

(21) Appl. No.: 10/094,131

(22) Filed: Mar. 8, 2002

(51) Int. Cl. G09B 23/26

(52) U.S. Cl. 434/279

(57) ABSTRACT

A three dimensional DNA model includes a plurality of interlocking nucleotide units that can be supported on a stand. Each nucleotide unit has a phosphate unit, a generally planar sugar unit and a planar base unit. The sugar and base units include representation of their chemical structures.

### BACKGROUND OF THE INVENTION

The present invention relates to models representing DNA molecules. More particularly, the present invention relates to models that can be used to teach concepts of DNA structure.

Deoxyribonucleic acid (DNA) is the main carrier of genetic information in almost all living organizations. Knowledge concerning the structure and function of DNA has increased significantly over the past few decades. Instruction concerning the function and structure of DNA is becoming more common in schools at all levels. Although DNA is made up of a relatively few building blocks, its structure is difficult to visually understand and teach. DNA molecules are extremely long polymers, built of repeating deoxyribonucleotide units. Each unit includes a phosphate, a sugar, and either a purine or pyrimidine base. Alternating sugar and phosphate groups form the backbone of the molecule and the bases are attached to the sugars. The backbone is the same in all DNA molecules. It is the selection and order of the bases that differentiate DNA molecules.

Most DNA molecules are formed from two DNA chains wound round each other in a right-handed helix. The chains are linked together by hydrogen bonds formed between complementary bases. The four bases are adenine, cytosine, guanine and thymine. Adenine is always paired with thymine and guanine is always paired with cytosine. In the double helix structure, there are approximately ten base pairs per turn. In other words, there is a rotation of approximately 36° between the base pairs.

While DNA is a three dimensional structure forming a double helix, its components are often represented in textbooks and other teaching aids in two dimensions. Currently available DNA models do not relate the three dimensional physical model to the two dimensional structure depicted in textbooks. Accordingly, it is often difficult for students to correlate the two.

Accordingly, it would be a significant advancement in the art to provide a DNA model which could help students grasp the three dimensional structure of DNA and correlate it to the individual building blocks. Such a model is disclosed and claimed herein.

### SUMMARY OF THE INVENTION

The present invention is directed to a three dimensional model which can be used to teach the structure of DNA. In a preferred embodiment, the model comprises a plurality of interlocking nucleotide units including each of the nucleotides found in DNA. Each nucleotide unit is formed from a phosphate unit, a generally planar sugar unit, and a planar base unit. The generally planar sugar unit includes chemical representations of the sugar as it is usually depicted in two dimensions. The planar base unit includes chemical representations of each of the bases as they are generally represented in two dimensions. Additionally, the base unit contains a marking indicating whether it represents the nucleotide adenine, cytosine, guanine or thymine.

A plurality of the nucleotide units can be connected together to form a strand of the double helix of the DNA molecule. Additionally, two strands can be connected together with complementary bases being connected.

In a preferred embodiment, the model also includes a stand for supporting the DNA molecule. The stand includes a base formed from a plurality of legs and a column supporting a plurality of platforms. Each platform is free to rotate so that it can be aligned under a base pair at about 36° intervals.

### BRIEF DESCRIPTION OF THE DRAWINGS

FIG. 1 is a perspective view of the DNA model and stand of the present invention.

FIG. 2 is an exploded view of one of the interlocking nucleotide units.

FIGS. 3a-3d are perspective views of individual nucleotide units.

FIGS. 4a and 4b are perspective views of pairs of nucleotide units in which the complementary bases are connected.

### DETAILED DESCRIPTION

The present invention provides a model in which interlocking nucleotide units can be assembled to illustrate the three dimensional nature of the DNA molecule while clearly relating the structure of each nucleotide unit back to the two dimensional illustrations that are often used in textbooks and other teaching aids. The invention can best be understood by reference to the attached drawings in which like parts are designated with like numerals.

The model of the present invention is generally depicted at 10 and in its broadest sense includes a stand 12 which is formed from a base 14 having a plurality of legs 16. A column 18 extends upward from base 14 and includes a lower portion 20 to which legs 16 are attached and stackable sections 22. In the preferred embodiment, a platform 24 is attached to each stackable section 22 of column 18. A brace 26 between section 22 and platform 24 helps provide stability to each of the platforms. In the preferred embodiment, platforms 24 are narrow at the end at which they are attached to sections 22 and are wider at distal end 28. However, as will be apparent to those of skill in the art, the exact shape of platforms 24 is not critical to the present invention.

Stackable sections 22 include a narrower portion (not shown) which can be inserted into an adjacent section to form column 18. Stackable sections 22 are rotatable with respect to each other such that they can be spaced at about 36° intervals to support base pairs of the DNA model. While the preferred embodiment is formed from a plurality of stackable sections, each having a separate platform, it will be appreciated by those skilled in the art that many other configurations could also be utilized in the present invention. For example, the column could be a unitary structure with platforms being attached thereto.

Stand 12 supports DNA model 30 which is formed from a plurality of interlocking nucleotide units as will be described in greater detail below. As discussed above, DNA molecules are made up of four different nucleotides. These nucleotides are generally represented by the letters A, T, C and G representing the bases adenine, thymine, cytosine and guanine.

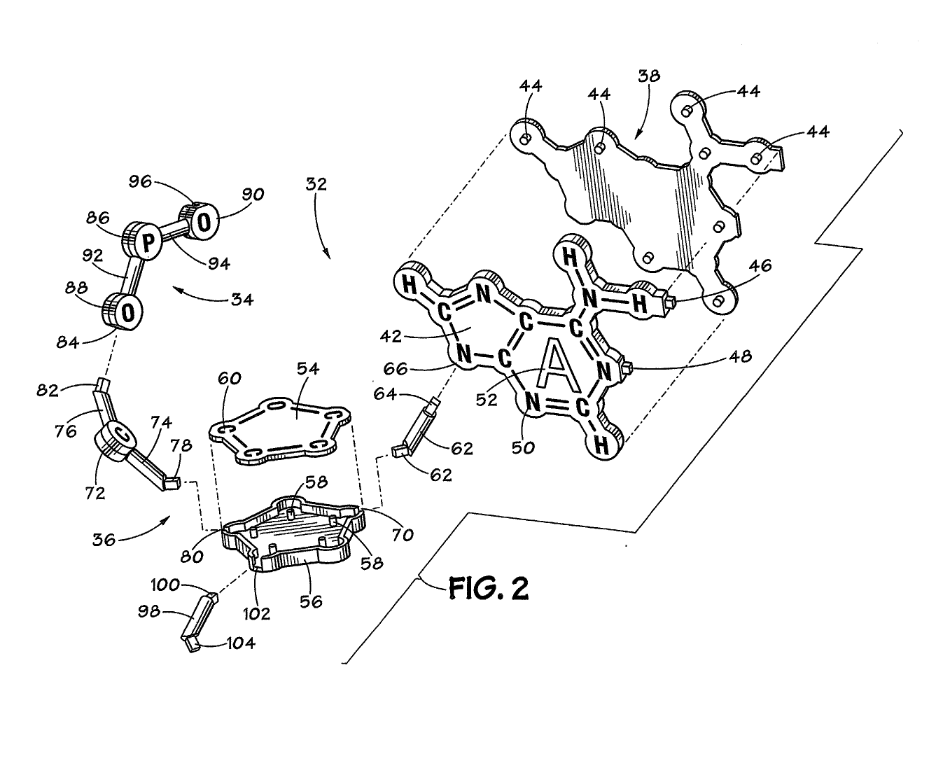

Referring next to FIG. 2, a nucleotide unit representing the base adenine is illustrated in an exploded view. Nucleotide 32 includes a phosphate unit generally designated at 34, a sugar unit generally designated at 36 and a base unit generally designated at 38. Base unit 38, in a preferred embodiment, is formed from a top plate 40 and a bottom plate 42. Top plate 40 includes a plurality of pegs 44 which snap into corresponding holes (not shown) in bottom plate 42. If desired, top plate 40 and bottom plate 42 can be glued together. Pegs 46 and 48 extend from a side of base unit 38 and are used to connect this base unit with a corresponding base unit representing thymine as discussed in greater detail below. The exposed planar faces of top plate 40 and bottom plate 42 include representations 50 of the chemical structure of adenine. The exposed faces also contain a large letter “A” 52 representing adenine.

The representations can be formed many different ways. In a preferred embodiment they are formed as raised letters and lines of the surface of the plates. They can also be formed as indentations. Alternatively, the representations can be painted or printed onto the surface.

The ring structure of sugar unit is also formed from a top plate 54 and a bottom plate 56. Bottom plate 56 includes a plurality of holes 58 which correspond to pegs (not shown) on top plate 54. Top plate 54 can be permanently affixed to bottom plate 56. The exposed planar surfaces of top plate 54 and bottom plate 56 include representations 60 of the chemical structure of the ring portion of the sugar unit. A molded carbon atom 72 (representing the 5′ carbon of deoxyribose) having arms 74 and 76 is connected to the ring portion of sugar unit 36 by a keyed peg 78 which engages slot 80. Keyed peg 82 engages a slot 84 in phosphate unit 34. Since the major portion of sugar unit 36 is formed by the plates representing the ring structure, sugar unit 36 will be described as generally planar in this application.

Sugar unit 36 is connected to base unit 38 by a connector 62. Connector 62 includes a keyed peg 64 which engages a slot 66 in the side of base unit 38. Connector 62 also includes a keyed peg 68 which engages a slot 70 in the side of sugar unit 36. Keyed pegs 64 and 68 are angled such that they position the two ring systems at the proper angles for forming a representative DNA molecule.

Phosphate unit 34 is formed from a molded phosphorus atom 86 and oxygen atoms 88 and 90. Oxygen atoms 88 and 90 are connected to phosphorus atom 86 by arms 92 and 94 which are positioned at the appropriate angles. Oxygen atom 90 includes a slot 96 which is used to connect adjoining nucleotides.

A connector 98 having a keyed peg 100 which engages slot 102 in the ring portion of sugar unit 36 is used to connect adjacent nucleotides. Connector 98 has a keyed peg 104 which engages slot 96 in oxygen 90 of an adjoining nucleotide.

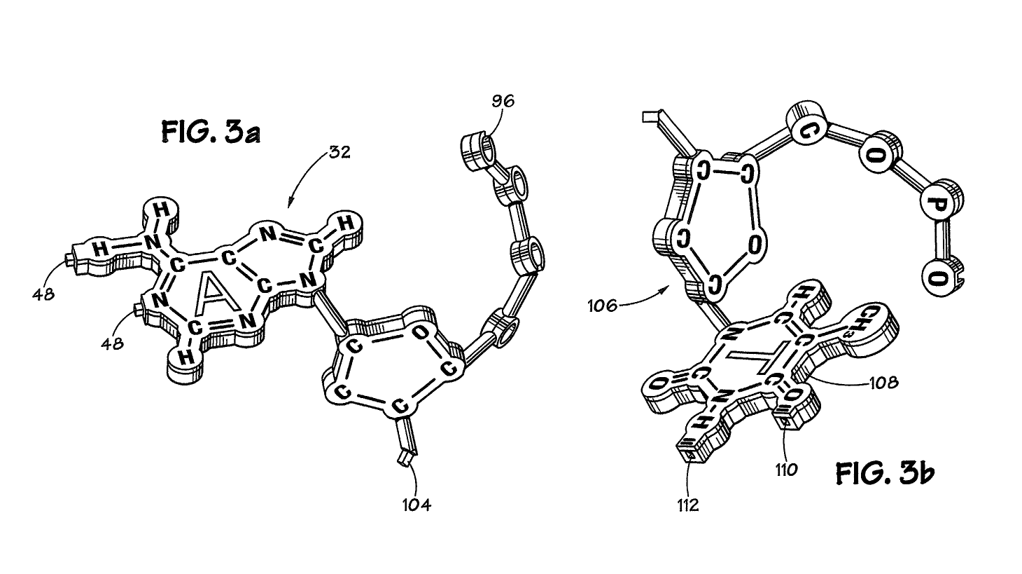

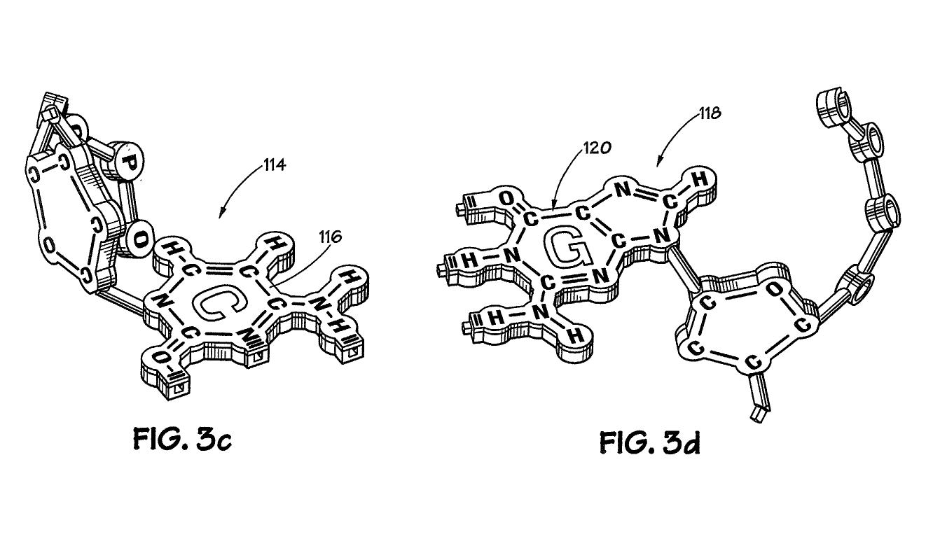

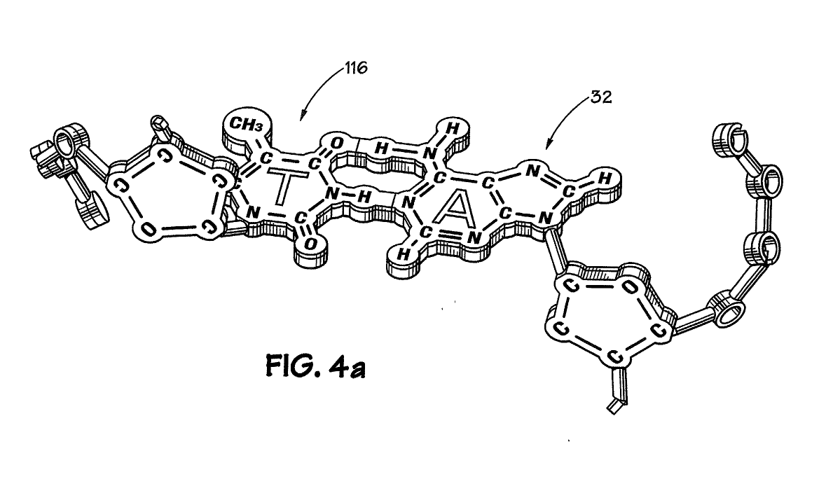

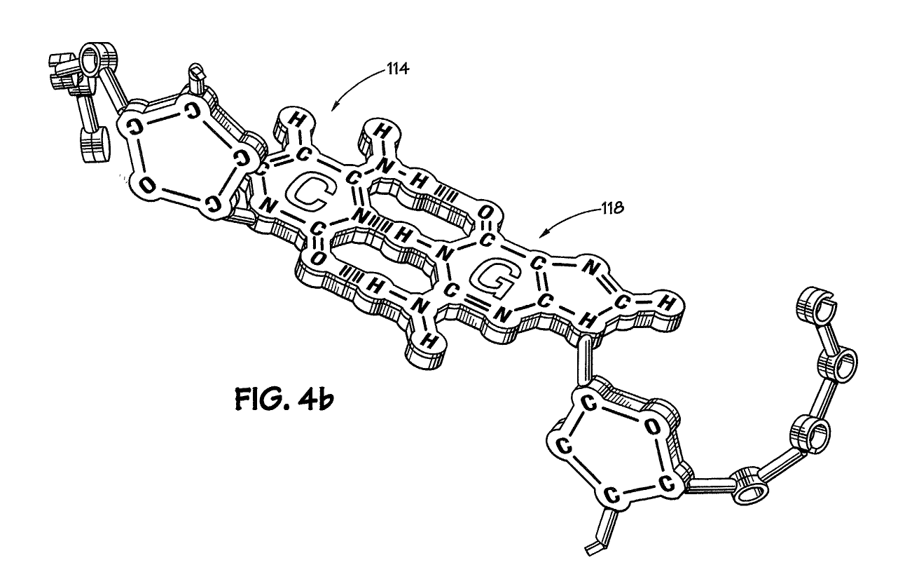

Reference is next made to FIGS. 3a-3d which illustrate the four different nucleotides which make up a DNA molecule. FIG. 3a represents the nucleotide 32 of FIG. 2 in fully assembled form. FIG. 3b illustrates nucleotide 106 which includes a base unit 108 representing thymine. Base unit 108 includes slots 110 and 112 which correspond to pegs 46 and 48 of base unit 32. Accordingly, nucleotides 32 and 106 can be assembled to form a complementary base pair as illustrated in FIG. 4a. The phosphate unit and sugar unit in nucleotide 106 are identical to the phosphate and sugar units in nucleotide 32. FIG. 3c illustrates nucleotide 114 which includes base unit 116 representing cytosine. FIG. 3d illustrates nucleotide 118 which contains base unit 120 representing guanine. Nucleotides 114 and 118 can be connected together to form a complementary base pair as illustrated in FIG. 4b.

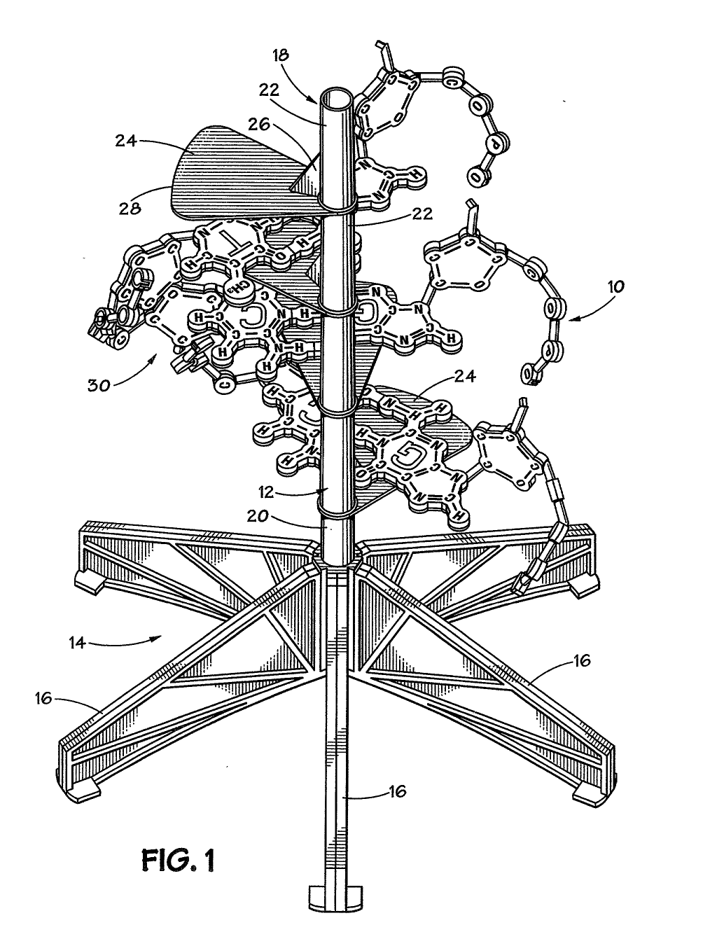

In the preferred embodiment, all of the parts forming model 10 are made out of molded plastic. Additionally, all of the parts making up each of the nucleotides are glued together using epoxy or another suitable adhesive. Accordingly, students can easily connect nucleotides together by connecting a phosphate unit of one nucleotide to a sugar unit of another nucleotide to create a strand of DNA. Additionally, complementary bases can be attached to each nucleotide in the strand to form a complementary base pair which, when connected with additional complementary base pairs, form the second strand of the DNA molecule. Stand 12 can be used to support the DNA molecule as additional nucleotides are added to the model. While FIG. 1 illustrates four platforms which can be used to support four complementary base pairs, it will be appreciated by those skilled in the art that many additional platforms can be added to the model. Ten platforms would be required to make one complete turn of the double helix of the DNA model.

While the invention has been described with respect to the presently preferred embodiments, it will be appreciated by those skilled in the art that numerous changes can be made to the illustrated embodiments without departing from the essence of the invention. Accordingly, the scope of the invention is to be determined by the following claims rather than by the foregoing description. All changes which come within the range of equivalency of the claims are to be embraced within their scope.

What is claimed is:

1. A DNA model comprising a plurality of interlocking nucleotide units, each nucleotide unit comprising a phosphate unit, a generally planar sugar unit and a planar base unit.

2. A DNA model according to claim 1 wherein said sugar unit includes representations of the chemical structure of the sugar.

3. A DNA model according to claim 1 wherein said base unit includes representations of the chemical structure of a base.

4. A DNA model according to claim 1 wherein said model includes at least four different base units representing adenine, cytosine, guanine and thymine.

5. A DNA model according to claim 1 further comprising a stand for supporting the nucleotide units.

6. A DNA model according to claim 5 wherein said stand comprises a base, a column, and a plurality of platforms.

7. A DNA model according to claim 6 wherein the column comprises a plurality of stackable sections.

8. A DNA model according to claim 7 wherein a platform is attached to each stackable section.

9. A DNA model comprising:
a base;
a plurality of platforms arranged in an upward spiral configuration supported by said base; and
a plurality of interlocking nucleotide units supported by said platforms wherein said nucleotide units can be assembled to represent the structure of DNA.

10. A DNA model according to claim 9 wherein each nucleotide unit comprises a phosphate unit, a generally planar sugar unit and a planar base unit.

11. A DNA model according to claim 10 wherein said sugar unit includes representations of the chemical structure of the sugar.

12. A DNA model according to claim 10 wherein said base unit includes representations of the chemical structure of a base.

13. A DNA model according to claim 10 wherein said base unit includes a letter representing a particular base.
